(19) United States
(12) Patent Application Publication
(10) Pub. No.: US 2016/0335391 A1
(43) Pub. Date: Nov. 17, 2016

(54) METHOD AND SYSTEM FOR INTERACTING RAIL TRANSIT VEHICLE COMMISSIONING TASK INFORMATION

(71) Applicant: CRRC QINGDAO SIFANG CO., LTD., Qingdao, Shandong (CN)

(72) Inventors: Chenyang BING, Qingdao, Shandong (CN); Huabo SHEN, Qingdao, Shandong (CN); Yao WANG, Qingdao, Shandong (CN); Jianbo ZHAO, Qingdao, Shandong (CN); Shun XU, Qingdao, Shandong (CN); Jie CHANG, Qingdao, Shandong (CN); Qunjiang ZHU, Qingdao, Shandong (CN); Xiaobao HOU, Qingdao, Shandong (CN)

(73) Assignee: CRRC QINGDAO SIFANG CO., LTD., Qingdao, Shandong (CN)

(21) Appl. No.: 15/112,967

(22) PCT Filed: Oct. 28, 2015
(86) PCT No.: PCT/CN2015/093068

§ 371 Date: Jul. 20, 2016

(30) Foreign Application Priority Data
Nov. 26, 2014 (CN) 201410698475.2

(51) Int. Cl. G06F 17/50

(52) U.S. Cl. CPC G06F 17/5095; G06F 2217/04

(57) ABSTRACT

A method and a system for interacting rail transit vehicle commissioning task information are provided. The system includes a server and a commissioning terminal, wherein the server generates a commissioning template and sends to the commissioning terminal the commissioning process promoting information. The commissioning terminal obtains the commission template, and may obtain commissioning result data corresponding to a current operation step promoted in a current commissioning process promoting information and send the commissioning result data to the server. The server judges the commissioning result data, generates and sends the judgment result to the commissioning terminal. The commissioning terminal fills the judgment result into the interacting region corresponding to the current operation step. Therefore, an electronic rail transit vehicle commissioning is achieved without manually filling a large amount of paper forms, which reduces workload of the commissioning worker and improves the efficiency of commissioning.

### CROSS REFERENCE OF RELATED APPLICATION

The present application claims priority to Chinese Patent Application No. 201410698475.2, titled “METHOD AND SYSTEM FOR INTERACTING RAIL TRANSIT VEHICLE COMMISSIONING TASK INFORMATION”, filed on Nov. 26, 2014 with the State Intellectual Property Office of People's Republic of China, which is incorporated herein by reference in its entirety.

### FIELD

The present disclosure relates to the technical field of information processing, and in particular to a method and a system for interacting rail transit vehicle commissioning task information.

### BACKGROUND

At present, in commissioning of a rail transit vehicle, commissioning data are mostly recorded in a paper file. In a case of a heavy task, a large amount of paper forms need to be filled, bringing hard work to a commissioning worker and resulting in low efficiency of commissioning because the commissioning data are all filled manually.

Therefore, it is desired to improve the efficiency of commissioning.

### SUMMARY

The present disclosure is directed to provide a method and a system for interacting rail transit vehicle commissioning task information in order to improve the efficiency of commissioning.

In order to achieve the above object, following technical solutions are provided according to the present disclosure.

A system for interacting rail transit vehicle commissioning task information includes a server and a commissioning terminal, where

the server is configured to generate a commissioning template, where the commissioning template includes a commissioning task, operation steps in the commissioning task, information which needs to be confirmed after each of the operation steps, and an interacting region for filling a judgment result corresponding to confirmed information; send, to the commissioning terminal, commissioning process promoting information based on an execution sequence of the operation steps in the commissioning task and a judgment result corresponding to a previous operation step; judge, based on a predetermined criterion corresponding to a current operation step promoted in the commissioning process promoting information, commissioning result data corresponding to the current operation step promoted in the commissioning process promoting information which are sent by the commissioning terminal; generate a judgment result corresponding to the commissioning result data; and send the judgment result to the commissioning terminal; and

the commissioning terminal is configured to obtain the commissioning template;

obtain the commissioning result data corresponding to a current operation step promoted in a current commissioning process promoting information after receiving the commissioning process promoting information from the server; send commissioning result information to the server, where the commissioning result information includes the commissioning result data, the operation step corresponding to the commissioning result data, and an identifier of the commissioning terminal; receive the judgment result corresponding to the commissioning result data from the server; and fill the judgment result into the interacting region corresponding to the current operation step promoted in the current commissioning process promoting information.

In the above system, the commissioning terminal is preferably a handheld terminal which is configured to: obtain and display the commissioning template; send to the server the commissioning result information if it is detected that a user inputs data into the interacting region corresponding to the current operation step after receiving the commissioning process promoting information from the server, where the commissioning result information includes commissioning result data inputted by the user, the operation step corresponding to the data inputted by the user, an equipment identifier of the handheld terminal and an identifier of the user of the handheld terminal; receive a judgment result corresponding to the commissioning result data from the server; and fill the judgment result into the interacting region corresponding to the current operation step.

In the above system, the commissioning terminal is preferably an instruction tester which is configured to: obtain the commissioning template; monitor an operable component and/or a simulation system of a rail transit vehicle after receiving the commissioning process promoting information from the server; collect a first operation instruction signal triggered by the operable component and send the first operation instruction signal to the server and/or collect a second operation instruction signal triggered by operation of the simulation system, when an action on the operable component corresponding to the current operation step and/or the operation of the simulation system corresponding to the current operation step is monitored; send the commissioning result information to the server, where the commissioning result information includes the first operation instruction signal and/or the second instruction signal, the operation step corresponding to the first operation instruction signal and/or the second instruction signal, and an equipment identifier of the instruction tester; receive a second judgment result corresponding to the first operation instruction signal and/or a third judgment result corresponding to the second operation instruction signal from the server; and fill the second judgment result and/or the third judgment result into the interacting region corresponding to the current operation step.

In the above system, the commissioning terminal is preferably an intelligent instrument which is configured to: measure an electrical parameter; obtain the commissioning template; send to the server the commissioning result information after receiving the commissioning process promoting information from the server, where the commissioning result information includes measurement result data, the operation step corresponding to the measurement result data, and an equipment identifier of the intelligent instrument; receive a fourth judgment result corresponding to the measurement result data from the server; and fill the fourth judgment result into the interacting region corresponding to the current operation step.

In the above system, the commissioning terminal preferably includes at least two of a handheld terminal, an instruction tester and an intelligent instrument;

the handheld terminal is configured to: obtain and display the commissioning template; send to the server the commissioning result information if it is detected that a user inputs data into the interacting region corresponding to the current operation step after receiving the commissioning process promoting information for the handheld terminal from the server, where the commissioning result information includes commissioning result data inputted by the user, the operation step corresponding to the data inputted by the user, an equipment identifier of the handheld terminal and an identifier of the user of the handheld terminal; receive a first judgment result corresponding to the commissioning result data from the server; and fill the first judgment result into the interacting region corresponding to the current operation step;

the instruction tester is configured to: obtain the commissioning template; monitor an operable component and/or a simulation system of a rail transit vehicle after receiving the commissioning process promoting information for the instruction tester from the server; collect a first operation instruction signal triggered by the operable component and send the first operation instruction signal to the server and/or collect a second operation instruction signal triggered by operation of the simulation system, when an action on the operable component corresponding to the current operation step and/or the operation of the simulation system corresponding to the current operation step is monitored; send the commissioning result information to the server, where the commissioning result information includes the first operation instruction signal and/or the second instruction signal, the operation step corresponding to the first operation instruction signal and/or the second instruction signal, and an equipment identifier of the instruction tester; receive a second judgment result corresponding to the first operation instruction signal and/or a third judgment result corresponding to the second operation instruction signal from the server; and fill the second judgment result and/or the third judgment result into the interacting region corresponding to the current operation step; and

the intelligent instrument is configured to: measure an electrical parameter; obtain the commissioning template; send to the server the commissioning result information after receiving the commissioning process promoting information for the intelligent instrument from the server, where the commissioning result information includes measurement result data, the operation step corresponding to the measurement result data, and an equipment identifier of the intelligent instrument; receive a fourth judgment result corresponding to the measurement result data from the server; and fill the fourth judgment result into the interacting region corresponding to the current operation step.

A method for interacting rail transit vehicle commissioning task information, includes:

generating, by a server, a commissioning template, where the commissioning template includes a commissioning task, operation steps in the commissioning task, information which needs to be confirmed after each of the operation steps, and an interacting region for filling a judgment result corresponding to confirmed information;

obtaining, by a commissioning terminal, the commissioning template;

sending, by the server to the commissioning terminal, commissioning process promoting information based on an execution sequence of the operation steps in the commissioning task and a judgment result corresponding to a previous operation step;

obtaining, by the commissioning terminal, commissioning result data corresponding to a current operation step promoted in a current commissioning process promoting information after the commissioning process promoting information is received by the commissioning terminal from the server;

sending, by the commissioning terminal to the server, commissioning result information, where the commissioning result information includes the commissioning result data, the operation step corresponding to the commissioning result data, and an identifier of the commissioning terminal;

judging, by the server based on a predetermined criterion corresponding to the current operation step promoted in the commissioning process promoting information after the commissioning result information is received by the server from the commissioning terminal, the commissioning result data corresponding to the current operation step promoted in the commissioning process promoting information which are sent by the commissioning terminal, and generating, by the server, a judgment result corresponding to the commissioning result data;

sending, by the server, the judgment result to the commissioning terminal; and

filling, by the commissioning terminal, the judgment result into the interacting region corresponding to the current operation step promoted in the current commissioning process promoting information after the judgment result is received by the commissioning terminal from the server.

In the above method, the commissioning terminal is preferably a handheld terminal, the method further includes displaying, by the commissioning terminal, the commissioning template; and

the obtaining, by the commissioning terminal, the commissioning result data corresponding to the current operation step promoted in the current commissioning process promoting information includes:

receiving, by the commissioning terminal, the commissioning result data corresponding to the current operation step promoted in the current commissioning process promoting information which are inputted by a user.

In the above method, the commissioning terminal is preferably an instruction tester, and the obtaining, by the commissioning terminal, the commissioning result data corresponding to the current operation step promoted in the current commissioning process promoting information includes:

monitoring, by the commissioning terminal, an operable component and/or a simulation system of a rail transit vehicle; and collecting, by the commissioning terminal, a first operation instruction signal triggered by the operable component and sending, by the commissioning terminal, the first operation instruction signal to the server and/or collecting, by the commissioning terminal, a second operation instruction signal triggered by operation of the simulation system, when an action on the operable component corresponding to the current operation step and/or the operation of the simulation system corresponding to the current operation step is monitored, where the first operation instruction signal and/or the second operation instruction signal are included in the commissioning result data corresponding to the current operation step promoted in the current commissioning process promoting information.

In the above method, the commissioning terminal is preferably an intelligent instrument, and the obtaining, by the commissioning terminal, the commissioning result data corresponding to the current operation step promoted in the current commissioning process promoting information includes:

measuring, by the commissioning terminal, an electrical parameter, where the measured electrical parameter is included in the commissioning result data corresponding to the current operation step promoted in the current commissioning process promoting information.

A method for interacting rail transit vehicle commissioning task information is applied to a system for interacting rail transit vehicle commissioning task information, where the system for interacting rail transit vehicle commissioning task information includes a server and multiple commissioning terminals connected to the server, the commissioning terminals include at least two of a handheld terminal, an instruction tester and an intelligent instrument, and the method includes:

generating, by the server, a commissioning template, where the commissioning template includes a commissioning task, operation steps in the commissioning task, information which needs to be confirmed after each of the operation steps, and an interacting region for filling a judgment result corresponding to confirmed information;

obtaining, by the commissioning terminals, the commissioning template;

sending, by the server to the commissioning terminals, commissioning process promoting information based on an execution sequence of the operation steps in the commissioning task and a judgment result corresponding to a previous operation step;

sending, by the handheld terminal to the server if the commissioning terminals include the handheld terminal, commissioning result information if it is detected that a user inputs data into the interacting region corresponding to a current operation step after the commissioning process promoting information for the handheld terminal is received by the handheld terminal from the server, where the commissioning result information includes commissioning result data inputted by the user, the operation step corresponding to the data inputted by the user, an equipment identifier of the handheld terminal and an identifier of the user of the handheld terminal;

monitoring, by the instruction tester if the commissioning terminals include the instruction tester, an operable component and/or a simulation system of a rail transit vehicle after the commissioning process promoting information for the instruction tester is received by the instruction tester from the server; collecting, by the instruction tester, a first operation instruction signal triggered by the operable component and sending, by the instruction tester, the first operation instruction signal to the server and/or collecting, by the instruction tester, a second operation instruction signal triggered by operation of the simulation system, when an action on the operable component corresponding to the current operation step and/or the operation of the simulation system corresponding to the current operation step is monitored; sending, by the instruction tester to the server, commissioning result information, where commissioning result information includes the first operation instruction signal and/or the second instruction signal, the operation step corresponding to the first operation instruction signal and/or the second instruction signal, and an equipment identifier of the instruction tester;

sending, by the intelligent instrument to the server if the commissioning terminals include the intelligent instrument, the commissioning result information after the commissioning process promoting information for the intelligent instrument is received by the intelligent instrument from the server, where the commissioning result information includes measurement result data, the operation step corresponding to the measurement result data, and an equipment identifier of the intelligent instrument;

judging, by the server based on a predetermined criterion corresponding to a current operation step promoted in the commissioning process promoting information after the commissioning result information is received by the server, commissioning result data corresponding to the current operation step promoted in the commissioning process promoting information which are sent by the commissioning terminal, and generating, by the server, a judgment result corresponding to the commissioning result data;

sending, by the server, the judgment result to the commissioning terminals; and

filling, by the commissioning terminals, the judgment result into the interacting region corresponding to the current operation step promoted in the current commissioning process promoting information after the judgment result is received by the commissioning terminals from the server.

It follows from the above technical solution that, in the method and system for interacting rail transit vehicle commissioning task information according to the embodiments of the present disclosure, the server generates the commissioning template, and sends to the commissioning terminal the commissioning process promoting information based on the execution sequence of the operation steps in the commissioning task and a judgment result corresponding to a previous operation step. The commissioning terminal obtains the commission template, and may obtain commissioning result data corresponding to a current operation step promoted in a current commissioning process promoting information after the commissioning process promoting information is received by the commissioning terminal from the server, and send the commissioning result data to the server. The server judges, based on the predetermined criterion corresponding to the current operation step promoted in the commissioning process promoting information, the commissioning result data corresponding to the current operation step promoted in the commissioning process promoting information which are sent by the commissioning terminal, generates the judgment result, and sends the judgment result to the commissioning terminal. The commissioning terminal fills the judgment result into the interacting region corresponding to the current operation step promoted in the commissioning process promoting information.

With the method and system for interacting rail transit vehicle commissioning task information provided according to the present disclosure, the commissioning process is controlled by the server with the commissioning template. The commissioning result data (which may be inputted by a commissioning worker or obtained automatically by the commissioning terminal) of different commissioning phases are obtained by the commissioning terminal based on the commissioning process prompting information sent by the server, and are sent to the server. Thereby the server may process the commissioning result data to obtain the judgment result on the commissioning result data. Then the server sends the judgment result to the commissioning terminal, to be filled by the commissioning terminal into a corresponding region in the commissioning template obtained by the commissioning terminal. In this way, an electronic rail transit vehicle commissioning is achieved without manually filling a large amount of paper forms by a commissioning worker, which reduces workload of the commissioning worker and improves the efficiency of commissioning.

### BRIEF DESCRIPTION OF THE DRAWINGS

The accompanying drawings needed to be used in the description of the embodiments or the conventional technology are described briefly as follows, so that the technical solutions according to the embodiments of the present disclosure or according to the conventional technology become clearer. It is apparent that the accompanying drawings in the following description are only some embodiments of the present disclosure. For those skilled in the art, other accompanying drawings may be obtained according to these accompanying drawings without any creative work.

FIG. 1 is a structural schematic diagram of a system for interacting rail transit vehicle commissioning task information according to an embodiment of the present disclosure;

FIG. 2 is another structural schematic diagram of a system for interacting rail transit vehicle commissioning task information according to an embodiment of the present disclosure; and

FIG. 3 is a flowchart of a method for interacting rail transit vehicle commissioning task information according to an embodiment of the present disclosure.

### DETAILED DESCRIPTION OF EMBODIMENTS

The technical solution according to the embodiments of the present disclosure is described clearly and completely as follows in conjunction with the accompanying drawings in the embodiments of the present disclosure. It is apparent that the described embodiments are only a part of the embodiments according to the present disclosure, rather than all of the embodiments. All the other embodiments obtained by those skilled in the art based on the embodiments in the present disclosure without any creative work fall into the scope of the present disclosure.

A rail transit vehicle described in the present disclosure includes but is not limited to a motor train unit, a high speed train or a subway vehicle.

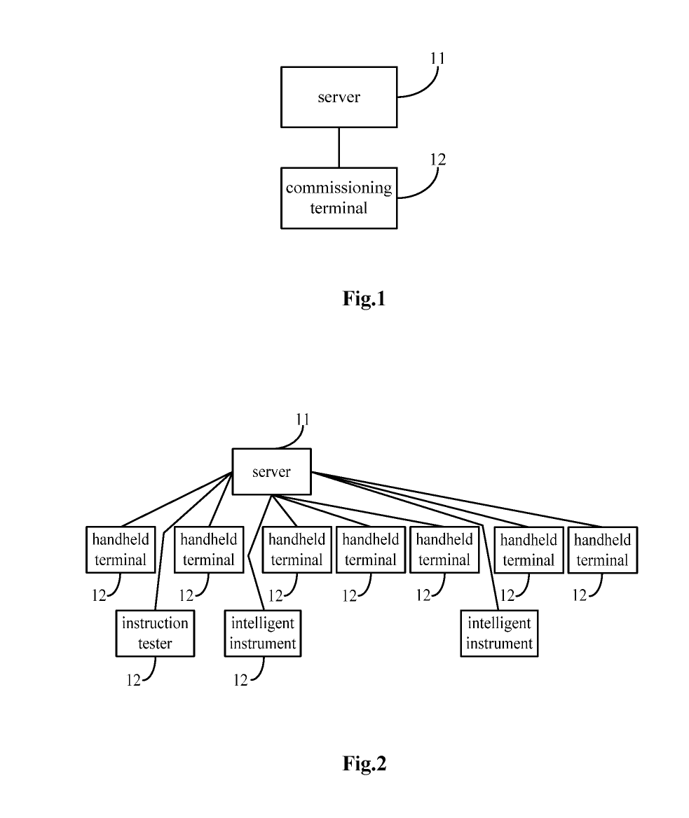

FIG. 1 is a structural schematic diagram of a system for interacting rail transit vehicle commissioning task information according to an embodiment of the present disclosure. Referring to FIG. 1, the system may include a server 11 and a commissioning terminal 12. The server 11 is configured to generate a commissioning template. The commissioning template may include a commissioning task, operation steps in the commissioning task, information which needs to be confirmed after each of the operation steps are finished, and an interacting region for filling a judgment result corresponding to confirmed information.

An example of the commissioning template is shown in Table 1, which may be in a form of Excel.

TABLE 1

| | | | | T1 | M1 |
|---|---|---|---|---|---|
| Item | Operation | Confirmation | Region | Judgment | |
| pyrotechnic | 1) screen of a | None | | | |
| alarm system | pyrotechnic alarm | | | | |
| | host | | | | |
| | Close a [pyrotechnic | A normal condition is | | | |
| | alarm] circuit breaker | displayed on the screen | | | |
| | for each vehicle | of the pyrotechnic alarm | | | |
| | | host without fault | | | |
| | | information of vehicle 1 | | | |
| | | to vehicle 8 | | | |
| | Vehicle main control | None | | | |
| | board is in use, VCB | | | | |
| | OFF, determine | | | | |
| | operation of the | | | | |
| | pyrotechnic alarm | | | | |
| | host and circuit | | | | |
| | module for each | | | | |
| | vehicle | | | | |
| | 2) Measure | DC (19~30) V | | | |
| | Measure an output | | | | |
| | voltage of a power | | | | |
| | supply module for a | | | | |
| | circuit module | | | | |
| | Measure line voltages | DC (19~38) V | | | |
| | at port A and port B | | | | |
| | (1139, 1140) of a | | | | |
| | circuit module in a | | | | |
| | switch panel | | | | |
| | 3) Fire alarm | At the pyrotechnic alarm | | | |
| | Release smoke at a | host, an MON fire alarm | | | |
| | monitoring port of a | is triggered, and a | | | |
| | sensor (confirm one | displayed sensor position | | | |
| | by one from vehicle | is correct | | | |
| | 1) | A fire alarm indicator | | | |
| | | lamp of the pyrotechnic | | | |
| | | alarm host flashes, and a | | | |
| | | fire alarm buzzer rings | | | |
| | | A fire alarm lamp of a | | | |
| | | circuit module in the | | | |
| | | switch panel is lighted | | | |

Table 1 illustrates commissioning task data as contents of item, operation, confirmation, region, and judgment, data of which may be stored in different tables in a database respectively. In order to facilitate transmission, the template may be converted into a data stream file (for example, in a form of XML) to be stored.

In Table 1, “Item” represents a commissioning task or a commissioning subtask during a commissioning process. That is, a whole commissioning process may include only one commissioning task or include multiple commissioning tasks. “Operation” represents operation steps for performing the commissioning task. “Confirmation” represents information which needs to be confirmed after each of the operation steps. “Region” represents a position where an operation step is performed. “Judgment” represents a judgment result obtained by judging the confirmed information. “T1” and “M1” are carriage numbers. Blank table cells in the columns of “Region” and “Judgment” are interacting regions with a user.

The server 11 is further configured to send to the commissioning terminal 12, commissioning process promoting information based on an execution sequence of the operation steps in the commissioning task and a judgment result corresponding to a previous operation step.

The execution sequence of the operation steps may be predetermined according to commissioning requirements. In the embodiment, the commissioning process promoting information may be sent to the commissioning terminal 12 in a case that a judgment result corresponding to a previous operation step indicates that a commissioning object corresponding to the previous operation step is normal, in order to cause the commissioning terminal 12 to perform a current operation step or promote a user of the commissioning terminal 12 to perform a commissioning process corresponding to the current operation step. The commissioning process promoting information is not sent to the commissioning terminal 12 in a case that a judgment result corresponding to a previous operation step indicates that a commissioning object corresponding to the previous operation step is abnormal, in order to prevent the abnormal commissioning object being associated with a subsequent commissioning object in the commissioning process to affect accuracy of subsequent commissioning data, thereby avoiding unnecessary commissioning.

The commissioning process promoting information includes the current operation step and an operation step to be performed after the current operation step.

Before the commissioning, the commissioning terminal 12 needs to obtain the commissioning template generated by the server 11 in either one of two following manners. In a first manner, the server 11 actively sends the commissioning template to the commissioning terminal 12 after the commissioning template is generated or updated. In a second manner, the commissioning terminal 12 sends a downloading request to the server 11 and the server 11 sends the commissioning template to the commissioning terminal 12 upon receiving the downloading request from the commissioning terminal 12.

The commissioning terminal 12 is configured to obtain commissioning result data corresponding to the current operation step promoted in the commissioning process promoting information after receiving the commissioning process promoting information from the server 11. Specifically, the commissioning result data may be automatically obtained by the terminal, or manually input by a user of the commissioning terminal 12 on the commissioning terminal 12. In a case that the user is required to manually input the commissioning result data, the user may be provided with options to be selected by the user for inputting the commissioning result data. Alternatively, the user may perform a corresponding clicking operation to input the commissioning result data. For example, in a case that a word “good” is intended to be filled, the user may single-click on an interface, the commissioning terminal 12 feeds back an instruction of single-click to the server 11 after detecting the operation of single-click, and the server 11 returns the commissioning result data as “good” corresponding to the instruction of single-click, thereby inputting the word “good”. In a case that a word “failed” is intended to be filled, the user may double-click on the interface, the commissioning terminal 12 feeds back an instruction of double-click to the server 11 after detecting the operation of double-click, and the server 11 returns the commissioning result data as “failed” corresponding to the instruction of double-click, thereby inputting the word “failed”.

The commissioning terminal 12 is further configured to send commissioning result information to the server 11 after obtaining the commissioning result data. The commissioning result information includes the commissioning result data, the operation step corresponding to the commissioning result data, and an identifier of the commissioning terminal 12. The commissioning result data are sent by the commissioning terminal 12 to the server 11, and then are judged by the server 11. In sending the commissioning result information by the commissioning terminal 12 to the server 11, the commissioning result information is converted into a form of XML.

The server 11 is further configured to judge, based on a predetermined criterion corresponding to a current operation step promoted in the commissioning process promoting information, commissioning result data corresponding to the current operation step promoted in the commissioning process promoting information which are sent by the commissioning terminal 12, generate a judgment result corresponding to the current operation step promoted in the commissioning process promoting information, and send the judgment result to the commissioning terminal 12. The server 11 may be further configured to fill the judgment result into the commissioning template.

The commissioning terminal 12 is further configured to fill the judgment result into the interacting region corresponding to the current operation step promoted in the current commissioning process promoting information after receiving the judgment result from the server 11.

It is possible to provide multiple commissioning terminals 12 according to commissioning requirements. For example, if each carriage of a rail transit vehicle needs to be tested, each carriage may be arranged with a separate commissioning terminal 12.

The server 11 may communicate with the commissioning terminals 12 via a wireless communication module or a wired communication module.

In the system for interacting rail transit vehicle commissioning task information according to the embodiment of the present disclosure, the commissioning process is controlled by the server 11 with the commissioning template. The commissioning result data (which may be inputted by a commissioning worker or obtained automatically by the commissioning terminal 12) of different commissioning phases are obtained by the commissioning terminal 12 based on the commissioning process prompting information sent by the server 11, and are sent to the server 11. Thereby the server 11 may process the commissioning result data to obtain the judgment result on the commissioning result data. Then the server 11 sends the judgment result to the commissioning terminal 12, to be filled by the commissioning terminal 12 into a corresponding region in the commissioning template obtained by the commissioning terminal 12. In this way, an electronic rail transit vehicle commissioning is achieved without manually filling a large amount of paper forms by a commissioning worker, which reduces workload of the commissioning worker and improves the efficiency of commissioning.

In addition, with the system for interacting rail transit vehicle commissioning task information according to the embodiment of the present disclosure, the accuracy of commissioning data is also improved because the data are not filled manually by the commissioning worker.

In the above embodiment, the commissioning terminal 12 may optionally include a handheld terminal, such as a panel computer or a handheld computer.

The handheld terminal is configured to display the commissioning template after obtaining the commissioning template, and detect whether a user inputs data into the interacting region corresponding to the current operation step after receiving the commissioning process promoting information from the server 11. The handheld terminal sends commissioning result information to the server 11 if it is detected that the user inputs data into the interacting region corresponding to the current operation step. The commissioning result information includes commissioning result data inputted by the user, the operation step corresponding to the data inputted by the user, an equipment identifier of the handheld terminal and an identifier of the user of the handheld terminal.

In the embodiment, the commissioning result information includes the identifier of the user of the handheld terminal, in order to identify the commissioning worker for facilitating management of commissioning workers.

The data inputted by the user may be a numerical value, such as 0, 1 or 20, which may be binary, decimal, of course, or in other number system, and is not limited herein. The data may also be in text, such as “good”, or “failed”.

The handheld terminal is further configured to receive from the server 11 a first judgment result corresponding to the commissioning result data sent by the handheld terminal, and fill the first judgment result into the interacting region corresponding to the current operation step.

In order to facilitate recognition for the user, a mark corresponding to the judgment result may be added to the interacting region where the judgment result is filled. For example, if the judgment result indicates that the commissioning object is abnormal (failed or irregular), the interacting region is marked in red.

In the embodiment as shown in FIG. 1, the commissioning terminal 12 may optionally include an instruction tester. The instruction tester is configured to monitor an operable component and/or a simulation system of a rail transit vehicle after receiving the commissioning process promoting information from the server 11.

The operable component in the rail transit vehicle to be monitored by the instruction tester may be determined in advance according to commissioning requirements. The instruction tester may further simulate a system (such as a brake/traction system, a cab control system, or an operation state) in the rail transit vehicle, to reproduce practical operation of the real vehicle for further improving the efficiency of commissioning. The simulation system to be monitored by the instruction tester may be selected by the user.

When an action on the operable component corresponding to the current operation step and/or operation of the simulation system corresponding to the current operation step is monitored by the instruction tester, the instruction tester collects a first operation instruction signal triggered by the operable component and sends the first operation instruction signal to the server 11 and/or collects a second operation instruction signal triggered by the operation of the simulation system. Then the instruction tester sends commissioning result information to the server 11. The commissioning result information includes the first operation instruction signal and/or the second operation instruction signal, the operation step corresponding to the first operation instruction signal and/or the second operation instruction signal, and an equipment identifier of the instruction tester.

Depending on different commissioning tasks, some commissioning tasks may only include an action on an operable component, i.e., an operation performed by the user on the operable component; some commissioning tasks may only include operation of a simulation system; and other commissioning tasks may include both an action on an operable component and operation of a simulation system.

The instruction tester is further configured to receive a second judgment result corresponding to the first operation instruction signal and/or a third judgment result corresponding to the second operation instruction signal from the server 11, and fill the second judgment result and/or the third judgment result into the interacting region corresponding to the current operation step.

In the embodiment as shown in FIG. 1, the commissioning terminal 12 may optionally include an intelligent instrument, such as an intelligent voltage meter or an intelligent ammeter.

The intelligent instrument is configured to measure an electrical parameter, such as a voltage, a current or a frequency. The intelligent instrument sends to the server 11 the commissioning result information after receiving the commissioning process promoting information from the server 11. The commissioning result information includes measurement result data, the operation step corresponding to the measurement result data, and an equipment identifier of the intelligent instrument.

The intelligent instrument may activate an electrical parameter measuring function to measure an electrical parameter and send the commissioning result information to the server 11, only if the current operation step promoted in the commission process promoting information includes measuring the electrical parameter. Otherwise, the electrical parameter measuring function is shut off to reduce power consumption of the intelligent instrument.

The intelligent instrument is further configured to receive a fourth judgment result corresponding to the measurement result data from the server 11, and fill the fourth judgment result into the interacting region corresponding to the current operation step.

In the above embodiment, the commissioning terminal 12 includes one of the handheld terminal, the instruction tester and the intelligent instrument. Furthermore, the commissioning terminal 12 may optionally include at least two of the handheld terminal, the instruction tester and the intelligent instrument. That is, the commissioning terminal 12 may include the handheld terminal and the instruction tester, the handheld terminal and the intelligent instrument, or the instruction tester and the intelligent instrument, or include all of the handheld terminal, the instruction tester and the intelligent instrument.

The handheld terminal is configured to obtain and display the commissioning template, and send to the server 11 the commissioning result information if it is detected that a user inputs data into the interacting region corresponding to the current operation step after receiving the commissioning process promoting information for the handheld terminal from the server 11.

The commissioning result information includes commissioning result data inputted by the user, the operation step corresponding to the data inputted by the user, an equipment identifier of the handheld terminal and an identifier of the user of the handheld terminal. The handheld terminal is further configured to receive a first judgment result corresponding to the commissioning result data from the server 11, and fill the first judgment result into the interacting region corresponding to the current operation step.

The instruction tester is configured to obtain the commissioning template, and monitor an operable component and/or a simulation system of a rail transit vehicle after receiving the commissioning process promoting information for the instruction tester from the server 11. The instruction tester is further configured to collect a first operation instruction signal triggered by the operable component and send the first operation instruction signal to the server 11 and/or collect a second operation instruction signal triggered by the operation of the simulation system, when an action on the operable component corresponding to the current operation step and/or operation of the simulation system corresponding to the current operation step is monitored. The instruction tester is further configured to send to the server 11 the commissioning result information. The commissioning result information includes the first operation instruction signal and/or the second instruction signal, the operation step corresponding to the first operation instruction signal and/or the second instruction signal, and an equipment identifier of the instruction tester. The instruction tester is further configured to receive a second judgment result corresponding to the first operation instruction signal and/or a third judgment result corresponding to the second operation instruction signal from the server 11, and fill the second judgment result and/or the third judgment result into the interacting region corresponding to the current operation step.

The intelligent instrument is configured to measure an electrical parameter, obtain the commissioning template, and send to the server 11 the commissioning result information after receiving the commissioning process promoting information for the intelligent instrument from the server 11. The commissioning result information includes measurement result data, the operation step corresponding to the measurement result data, and an equipment identifier of the intelligent instrument. The intelligent instrument is further configured to receive a fourth judgment result corresponding to the measurement result data from the server 11, and fill the fourth judgment result into the interacting region corresponding to the current operation step.

In an embodiment of the present disclosure, if multiple commissioning terminals 12 are provided, the server 11 sends the commissioning process prompting information to the commissioning terminals 12 in a broadcast manner. Each of the commissioning terminals 12 performs subsequent steps of the respective commissioning terminal 12 only if receiving the commissioning process prompting information for the respective commissioning terminal 12.

Multiple commissioning terminals 12 of different types may be provided according to commissioning requirements. For example, each carriage may be arranged with a handheld terminal, and a carriage controlled by a cab control system may be arranged with an instruction tester and an intelligent instrument. As shown in FIG. 2, which is another structural schematic diagram of a system for interacting rail transit vehicle commissioning task information according to an embodiment of the present disclosure, multiple commissioning terminals 12 of different types are included.

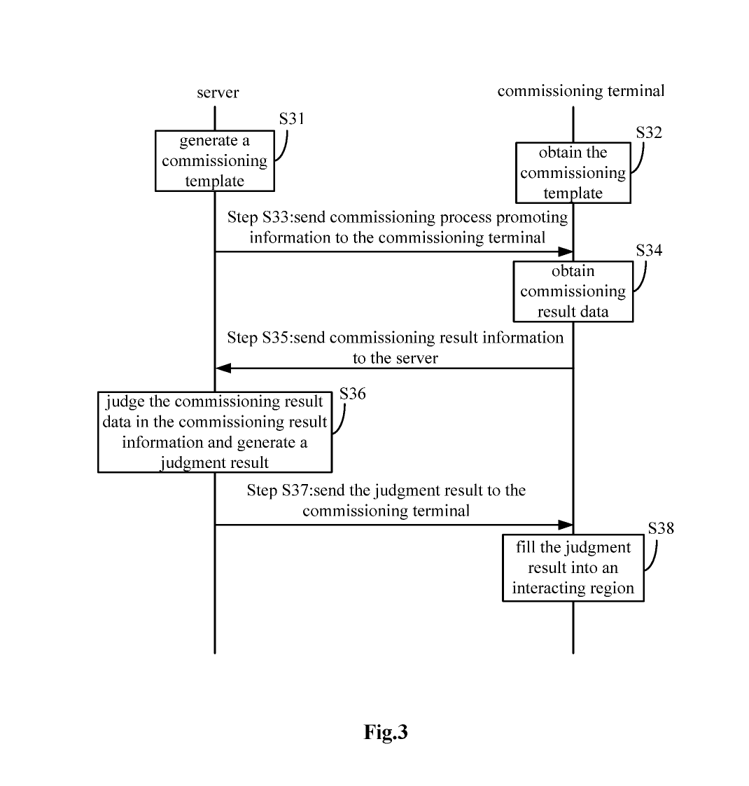

Corresponding to the system in the above embodiment, a method for interacting rail transit vehicle commissioning task information is further provided in the present disclosure. A structural schematic diagram of a system for interacting rail transit vehicle commissioning task information according to an embodiment of the present disclosure is shown in FIG. 3, which may include step S31 to step S38.

Step S31 includes generating, by a server 11, a commissioning template. The commissioning template includes a commissioning task, operation steps in the commissioning task, information which needs to be confirmed after each of the operation steps, and an interacting region for filling a judgment result corresponding to confirmed information.

Step S32 includes obtaining, by a commissioning terminal 12, the commissioning template.

Step S33 includes sending, by the server 11 to the commissioning terminal 12, commissioning process promoting information based on an execution sequence of the operation steps in the commissioning task and a judgment result corresponding to a previous operation step.

Step S34 includes obtaining, by the commissioning terminal 12, commissioning result data corresponding to a current operation step promoted in a current commissioning process promoting information after the commissioning process promoting information is received by the commissioning terminal from the server 11.

Step S35 includes sending, by the commissioning terminal 12 to the server 11, commissioning result information. The commissioning result information includes the commissioning result data, the operation step corresponding to the commissioning result data, and an identifier of the commissioning terminal 12.

Step S36 includes judging, by the server 11 based on a predetermined criterion corresponding to a current operation step promoted in the commissioning process promoting information after the commissioning result information is received by the server from the commissioning terminal 12, the commissioning result data corresponding to the current operation step promoted in the commissioning process promoting information which are sent by the commissioning terminal 12, and generating, by the server, a judgment result corresponding to the commissioning result data.

Step S37 includes sending, by the server 11, the judgment result to the commissioning terminal 12.

Step S38 includes filling, by the commissioning terminal 12, the judgment result into the interacting region corresponding to the current operation step promoted in the current commissioning process promoting information after receiving the judgment result from the server 11.

In the method for interacting rail transit vehicle commissioning task information according to the embodiment of the present disclosure, the commissioning process is controlled by the server 11 with the commissioning template. The commissioning result data (which may be inputted by a commissioning worker or obtained automatically by the commissioning terminal 12) of different commissioning phases are obtained by the commissioning terminal 12 based on the commissioning process prompting information sent by the server 11, and are sent to the server 11. Thereby the server 11 may process the commissioning result data to obtain the judgment result on the commissioning result data. Then the server 11 sends the judgment result to the commissioning terminal 12, to be filled by the commissioning terminal 12 into a corresponding region in the commissioning template obtained by the commissioning terminal 12. In this way, an electronic rail transit vehicle commissioning is achieved without manually filling a large amount of paper forms by a commissioning worker, which reduces workload of the commissioning worker and improves the efficiency of commissioning.

In addition, with the system for interacting rail transit vehicle commissioning task information according to the embodiment of the present disclosure, the accuracy of commissioning data is also improved because the data are not filled manually by the commissioning worker.

In the above embodiment, the commissioning terminal 12 may optionally include a handheld terminal and the method for interacting rail transit vehicle commissioning task information according to the embodiment of the present disclosure may further include displaying, by the commissioning terminal 12, the commissioning template.

The obtaining, by the commissioning terminal 12, the commissioning result data corresponding to the current operation step promoted in the current commissioning process promoting information may include a step as follows.

In the step, the commissioning terminal 12 receives the commissioning result data corresponding to the current operation step promoted in the current commissioning process promoting information which are inputted by a user.

Optionally, the commissioning terminal 12 may include an instruction tester, and the obtaining, by the commissioning terminal 12, the commissioning result data corresponding to the current operation step promoted in the current commissioning process promoting information may include a step as follows.

In the step, the commissioning terminal 12 monitors an operable component and/or a simulation system of a rail transit vehicle, collects a first operation instruction signal triggered by the operable component and sends the first operation instruction signal to the server 11 and/or collects a second operation instruction signal triggered by operation of the simulation system when an action on the operable component corresponding to the current operation step and/or the operation of the simulation system corresponding to the current operation step is monitored. The first operation instruction signal and/or the second operation instruction signal are included in the commissioning result data corresponding to the current operation step promoted in the current commissioning process promoting information.

Optionally, the commissioning terminal includes an intelligent instrument, and the obtaining, by the commissioning terminal 12, the commissioning result data corresponding to the current operation step promoted in the current commissioning process promoting information includes a step as follows.

In the step, the commissioning terminal 12 measures an electrical parameter. The measured electrical parameter is included in the commissioning result data corresponding to the current operation step promoted in the current commissioning process promoting information.

According to the present disclosure, another method for interacting rail transit vehicle commissioning task information is applied to a system for interacting rail transit vehicle commissioning task information. The system includes a server 11 and multiple commissioning terminals 12 connected to the server 11. The commissioning terminals 12 include at least two of a handheld terminal, an instruction tester and an intelligent instrument.

In the method, the server 11 generates a commissioning template. The commissioning template includes a commissioning task, operation steps in the commissioning task, information which needs to be confirmed after each of the operation steps, and an interacting region for filling a judgment result corresponding to confirmed information.

The commissioning terminals 12 obtain the commissioning template.

The server 11 sends to the commissioning terminals 12, commissioning process promoting information based on an execution sequence of the operation steps in the commissioning task and a judgment result corresponding to a previous operation step.

If the commissioning terminals 12 include the handheld terminal, the handheld terminal sends commissioning result information to the server 11 if it is detected that a user inputs data into the interacting region corresponding to a current operation step after the commissioning process promoting information for the handheld terminal is received by the handheld terminal from the server 11. The commissioning result information includes commissioning result data inputted by the user, the operation step corresponding to the data inputted by the user, an equipment identifier of the handheld terminal and an identifier of the user of the handheld terminal.

If the commissioning terminals 12 include the instruction tester, the instruction tester monitors an operable component and/or a simulation system of a rail transit vehicle after receiving the commissioning process promoting information for the instruction tester from the server 11. The instruction tester collects a first operation instruction signal triggered by the operable component and sends the first operation instruction signal to the server 11 and/or collects a second operation instruction signal triggered by operation of the simulation system, when an action on the operable component corresponding to the current operation step and/or the operation of the simulation system corresponding to the current operation step is monitored. The instruction tester sends commissioning result information to the server 11. The commissioning result information includes the first operation instruction signal and/or the second instruction signal, the operation step corresponding to the first operation instruction signal and/or the second instruction signal, and an equipment identifier of the instruction tester.

If the commissioning terminals 12 include the intelligent instrument, the intelligent instrument sends the commissioning result information to the server 11 after receiving the commissioning process promoting information for the intelligent instrument from the server 11. The commissioning result information includes measurement result data, the operation step corresponding to the measurement result data, and an equipment identifier of the intelligent instrument.

The server 11 judges, based on a predetermined criterion corresponding to a current operation step promoted in the commissioning process promoting information after the commissioning result information is received by the server, commissioning result data corresponding to the current operation step promoted in the commissioning process promoting information which are sent by the commissioning terminal 12, and generates a judgment result corresponding to the commissioning result data.

The server 11 sends the judgment result to the commissioning terminals 12.

The commissioning terminals 12 fill the judgment result into the interacting region corresponding to the current operation step promoted in the current commissioning process promoting information after receiving the judgment result from the server 11.

In the embodiments, no matter the judgment result generated by the server 11 corresponds to which commissioning terminal 12, the judgment result is sent to all the commissioning terminals 12 in a broadcast manner, and each of the commissioning terminals 12 fills the judgment result into the interacting region corresponding to the current operation step promoted in the current commissioning process promoting information.

The method and system for interacting rail transit vehicle commissioning task information according to the embodiments of the present disclosure may be implemented based on an android system.

It may be known by those skilled in the art that, units and steps in each example described in conjunction with the embodiments disclosed herein can be realized by electronic hardware, computer software or a combination thereof. Whether the function is executed in a hardware way or in a software way depends on a specific application and design constraint conditions of the technical solution. Those skilled in the art can use different method for each specific application to realize the described function, and this is not considered to be beyond the scope of the application.

In the embodiments according to the present application, it should be understood that the disclosed system and method may be implemented in other ways. For example, the system embodiments described above are only schematic. For example, the device is divided based on a logic function thereof, and they may be divided in another way in practice. For example, multiple devices or modules may be combined or integrated into another device, or some features may be omitted or not performed. In addition, a coupling, a direct coupling or a communication connection displayed or discussed herein may be an indirect coupling or communication connection via some interfaces, or devices, and may be in an electrical form, a mechanical form or another form.

In addition, each function unit according to each embodiment of the present disclosure may be integrated into one processing unit, or may be a separate unit physically, or two or more units are integrated into one unit.

With the above descriptions of the disclosed embodiments, the skilled in the art may practice or use the present disclosure. Various modifications to the embodiments are apparent for the skilled in the art. The general principle suggested herein can be implemented in other embodiments without departing from the spirit or scope of the disclosure. Therefore, the present disclosure should not be limited to the embodiments disclosed herein, but has the widest scope that is in conformity with the principle and the novel features disclosed herein.

1. A system for interacting rail transit vehicle commissioning task information, comprising a server and a commissioning terminal, wherein
the server is configured to:
generate a commissioning template, wherein the commissioning template comprises a commissioning task, operation steps in the commissioning task, information which needs to be confirmed after each of the operation steps, and an interacting region for filling a judgment result corresponding to confirmed information;
send, to the commissioning terminal, commissioning process promoting information based on an execution sequence of the operation steps in the commissioning task and a judgment result corresponding to a previous operation step;
judge, based on a predetermined criterion corresponding to a current operation step promoted in the commissioning process promoting information, commissioning result data corresponding to the current operation step promoted in the commissioning process promoting information which are sent by the commissioning terminal;
generate a judgment result corresponding to the commissioning result data; and
send the judgment result to the commissioning terminal; and
the commissioning terminal is configured to:
obtain the commissioning template;
obtain the commissioning result data corresponding to a current operation step promoted in a current commissioning process promoting information after receiving the commissioning process promoting information from the server;
send commissioning result information to the server, wherein the commissioning result information comprises the commissioning result data, the operation step corresponding to the commissioning result data, and an identifier of the commissioning terminal;
receive the judgment result corresponding to the commissioning result data from the server; and
fill the judgment result into the interacting region corresponding to the current operation step promoted in the current commissioning process promoting information.

2. The system according to claim 1, wherein the commissioning terminal is a handheld terminal which is configured to:
obtain and display the commissioning template;
send to the server the commissioning result information if it is detected that a user inputs data into the interacting region corresponding to the current operation step after receiving the commissioning process promoting information from the server, wherein the commissioning result information comprises commissioning result data inputted by the user, the operation step corresponding to the data inputted by the user, an equipment identifier of the handheld terminal and an identifier of the user of the handheld terminal;
receive a first judgment result corresponding to the commissioning result data from the server; and
fill the first judgment result into the interacting region corresponding to the current operation step.

3. The system according to claim 1, wherein the commissioning terminal is an instruction tester which is configured to:
obtain the commissioning template;
monitor an operable component and/or a simulation system of a rail transit vehicle after receiving the commissioning process promoting information from the server;
collect a first operation instruction signal triggered by the operable component and send the first operation instruction signal to the server and/or collect a second operation instruction signal triggered by operation of the simulation system, when an action on the operable component corresponding to the current operation step and/or the operation of the simulation system corresponding to the current operation step is monitored;
send the commissioning result information to the server, wherein the commissioning result information comprises the first operation instruction signal and/or the second instruction signal, the operation step corresponding to the first operation instruction signal and/or the second instruction signal, and an equipment identifier of the instruction tester;
receive a second judgment result corresponding to the first operation instruction signal and/or a third judgment result corresponding to the second operation instruction signal from the server; and
fill the second judgment result and/or the third judgment result into the interacting region corresponding to the current operation step.

4. The system according to claim 1, wherein the commissioning terminal is an intelligent instrument which is configured to:
measure an electrical parameter;
obtain the commissioning template;
send to the server the commissioning result information after receiving the commissioning process promoting information from the server, wherein the commissioning result information comprises measurement result data, the operation step corresponding to the measurement result data, and an equipment identifier of the intelligent instrument;
receive a fourth judgment result corresponding to the measurement result data from the server; and
fill the fourth judgment result into the interacting region corresponding to the current operation step.

5. The system according to claim 1, wherein the commissioning terminal includes at least two of a handheld terminal, an instruction tester and an intelligent instrument;
the handheld terminal is configured to:
obtain and display the commissioning template;
send to the server the commissioning result information if it is detected that a user inputs data into the interacting region corresponding to the current operation step after receiving the commissioning process promoting information for the handheld terminal from the server, wherein the commissioning result information comprises commissioning result data inputted by the user, the operation step corresponding to the data inputted by the user, an equipment identifier of the handheld terminal and an identifier of the user of the handheld terminal;
receive a first judgment result corresponding to the commissioning result data from the server; and
fill the first judgment result into the interacting region corresponding to the current operation step;
the instruction tester is configured to:
obtain the commissioning template;
monitor an operable component and/or a simulation system of a rail transit vehicle after receiving the commissioning process promoting information for the instruction tester from the server;
collect a first operation instruction signal triggered by the operable component and send the first operation instruction signal to the server and/or collect a second operation instruction signal triggered by operation of the simulation system, when an action on the operable component corresponding to the current operation step and/or the operation of the simulation system corresponding to the current operation step is monitored;
send the commissioning result information to the server, wherein the commissioning result information comprises the first operation instruction signal and/or the second instruction signal, the operation step corresponding to the first operation instruction signal and/or the second instruction signal, and an equipment identifier of the instruction tester;
receive a second judgment result corresponding to the first operation instruction signal and/or a third judgment result corresponding to the second operation instruction signal from the server; and
fill the second judgment result and/or the third judgment result into the interacting region corresponding to the current operation step; and
the intelligent instrument is configured to:
measure an electrical parameter;
obtain the commissioning template;
send to the server the commissioning result information after receiving the commissioning process promoting information for the intelligent instrument from the server, wherein the commissioning result information comprises measurement result data, the operation step corresponding to the measurement result data, and an equipment identifier of the intelligent instrument;
receive a fourth judgment result corresponding to the measurement result data from the server; and
fill the fourth judgment result into the interacting region corresponding to the current operation step.

6. A method for interacting rail transit vehicle commissioning task information, comprising:
generating, by a server, a commissioning template, wherein the commissioning template comprises a commissioning task, operation steps in the commissioning task, information which needs to be confirmed after each of the operation steps, and an interacting region for filling a judgment result corresponding to confirmed information;
obtaining, by a commissioning terminal, the commissioning template;
sending, by the server to the commissioning terminal, commissioning process promoting information based on an execution sequence of the operation steps in the commissioning task and a judgment result corresponding to a previous operation step;
obtaining, by the commissioning terminal, commissioning result data corresponding to a current operation step promoted in a current commissioning process promoting information after the commissioning process promoting information is received by the commissioning terminal from the server;
sending, by the commissioning terminal to the server, commissioning result information, wherein the commissioning result information comprises the commissioning result data, the operation step corresponding to the commissioning result data, and an identifier of the commissioning terminal;
judging, by the server based on a predetermined criterion corresponding to the current operation step promoted in the commissioning process promoting information after the commissioning result information is received by the server from the commissioning terminal, the commissioning result data corresponding to the current operation step promoted in the commissioning process promoting information which are sent by the commissioning terminal, and generating, by the server, a judgment result corresponding to the commissioning result data;
sending, by the server, the judgment result to the commissioning terminal; and
filling, by the commissioning terminal, the judgment result into the interacting region corresponding to the current operation step promoted in the current commissioning process promoting information after the judgment result is received by the commissioning terminal from the server.

7. The method according to claim 6, wherein the commissioning terminal is a handheld terminal,
the method further comprises displaying, by the commissioning terminal, the commissioning template; and
the obtaining, by the commissioning terminal, the commissioning result data corresponding to the current operation step promoted in the current commissioning process promoting information comprises:
receiving, by the commissioning terminal, the commissioning result data corresponding to the current operation step promoted in the current commissioning process promoting information which are inputted by a user.

8. The method according to claim 6, wherein the commissioning terminal is an instruction tester, and the obtaining, by the commissioning terminal, the commissioning result data corresponding to the current operation step promoted in the current commissioning process promoting information comprises:
monitoring, by the commissioning terminal, an operable component and/or a simulation system of a rail transit vehicle; and
collecting, by the commissioning terminal, a first operation instruction signal triggered by the operable component and sending, by the commissioning terminal, the first operation instruction signal to the server and/or collecting, by the commissioning terminal, a second operation instruction signal triggered by operation of the simulation system, when an action on the operable component corresponding to the current operation step and/or the operation of the simulation system corresponding to the current operation step is monitored, wherein the first operation instruction signal and/or the second operation instruction signal are included in the commissioning result data corresponding to the current operation step promoted in the current commissioning process promoting information.

9. The method according to claim 6, wherein the commissioning terminal is an intelligent instrument, and the obtaining, by the commissioning terminal, the commissioning result data corresponding to the current operation step promoted in the current commissioning process promoting information comprises:
measuring, by the commissioning terminal, an electrical parameter, wherein the measured electrical parameter is included in the commissioning result data corresponding to the current operation step promoted in the current commissioning process promoting information.

10. A method for interacting rail transit vehicle commissioning task information, applied to a system for interacting rail transit vehicle commissioning task information, wherein the system for interacting rail transit vehicle commissioning task information comprises a server and a plurality of commissioning terminals connected to the server, the commissioning terminals comprise at least two of a handheld terminal, an instruction tester and an intelligent instrument, and the method comprises:
generating, by the server, a commissioning template, wherein the commissioning template comprises a commissioning task, operation steps in the commissioning task, information which needs to be confirmed after each of the operation steps, and an interacting region for filling a judgment result corresponding to confirmed information;
obtaining, by the commissioning terminals, the commissioning template;
sending, by the server to the commissioning terminals, commissioning process promoting information based on an execution sequence of the operation steps in the commissioning task and a judgment result corresponding to a previous operation step;
sending, by the handheld terminal to the server if the commissioning terminals comprise the handheld terminal, commissioning result information if it is detected that a user inputs data into the interacting region corresponding to a current operation step after the commissioning process promoting information for the handheld terminal is received by the handheld terminal from the server, wherein the commissioning result information comprises commissioning result data inputted by the user, the operation step corresponding to the data inputted by the user, an equipment identifier of the handheld terminal and an identifier of the user of the handheld terminal;
monitoring, by the instruction tester if the commissioning terminals comprise the instruction tester, an operable component and/or a simulation system of a rail transit vehicle after the commissioning process promoting information for the instruction tester is received by the instruction tester from the server; collecting, by the instruction tester, a first operation instruction signal triggered by the operable component and sending, by the instruction tester, the first operation instruction signal to the server and/or collecting, by the instruction tester, a second operation instruction signal triggered by operation of the simulation system, when an action on the operable component corresponding to the current operation step and/or the operation of the simulation system corresponding to the current operation step is monitored;
sending, by the instruction tester to the server, commissioning result information, wherein the commissioning result information comprises the first operation instruction signal and/or the second instruction signal, the operation step corresponding to the first operation instruction signal and/or the second instruction signal, and an equipment identifier of the instruction tester;
sending, by the intelligent instrument to the server if the commissioning terminals comprise the intelligent instrument, the commissioning result information after the commissioning process promoting information for the intelligent instrument is received by the intelligent instrument from the server, wherein the commissioning result information comprises measurement result data, the operation step corresponding to the measurement result data, and an equipment identifier of the intelligent instrument;
judging, by the server based on a predetermined criterion corresponding to a current operation step promoted in the commissioning process promoting information after the commissioning result information is received by the server, the commissioning result data corresponding to the current operation step promoted in the commissioning process promoting information which are sent by the commissioning terminal, and generating, by the server, a judgment result corresponding to the commissioning result data;
sending, by the server, the judgment result to the commissioning terminals; and
filling, by the commissioning terminals, the judgment result into the interacting region corresponding to the current operation step promoted in the current commissioning process promoting information after the judgment result is received by the commissioning terminals from the server.
